(19) United States
(12) Patent Application Publication
(10) Pub. No.: US 2017/0068321 A1
(43) Pub. Date: Mar. 9, 2017

(54) Gesture Interactive Operation Method

(71) Applicant: Coretronic Corporation, Hsin-Chu (TW)

(72) Inventors: Pen-Ning Kuo, Hsin-Chu (TW); Chung-Lung Yang, Hsin-Chu (TW)

(21) Appl. No.: 15/186,821

(22) Filed: Jun. 20, 2016

(30) Foreign Application Priority Data
Sep. 8, 2015 (CN) 201510565543.2

(51) Int. Cl. G06F 3/01; G06F 3/041; G06F 3/0481; G06F 3/00

(52) U.S. Cl. CPC G06F 3/017; G06F 3/005; G06F 3/0416; G06F 3/04817

(57) ABSTRACT

A gesture interactive operation method includes: receiving image information, about a hand part and provided by an image sensor, when the hand part is located within a sensing range of the image sensor; defining, through an image processor, a space relationship among sequentially-adjacent first, second and third fingers of the hand part in the image information; and analyzing the image information to generate first or second initiation signal and initiating to execute first or second operating mode on the display screen, respectively. The first initiation signal corresponds to the image information indicating that the second and third fingers are physically contacted with each other and the second finger is not physically contacted with the first finger. The second initiation signal corresponds to the image information indicating that the first and second fingers are physically contacted with each other and the second finger is not physically contacted with the third finger.

### CROSS-REFERENCE TO RELATED APPLICATION

This application claims the priority benefit of Chinese application serial no. 201510565543.2, filed on Sep. 8, 2015. The entirety of the above-mentioned patent application is hereby incorporated by reference herein and made a part of this specification.

### FIELD OF THE INVENTION

The invention relates to a gesture interactive operation method, and more particularly to a gesture interactive operation method of a display screen.

### BACKGROUND OF THE INVENTION

With advances in technology, interactive touch method has been widely used in various electronic display devices.

Interactive electronic whiteboard is an example of an interactive touch method used with an electronic display device. In general, interactive electronic whiteboard is used as a two-way interaction between a whiteboard and a computer.

However, in the case of using a projector, a general electronic whiteboard needs an infrared light curtain generator for forming a planar light curtain, which is formed above and parallel with a display screen and for sensing an object approaching to the display screen, thereby executing a corresponding function (e.g., writing function or any specified function). Thus, the display screen must be a plane with high flatness, so that the vertical distance between the light curtain and the display screen is no need to increase for overcoming the low flatness of the display screen. And consequentially, the issue, which a corresponding touch operation is executed before the object actually touches the display screen and accordingly may lead to poor operation accuracy and using experience, is avoided. However, more manufacturing time and higher cost may require for a display screen with high flatness.

In addition, when a user tries to perform a gesture operation by using a projector and an interactive electronic whiteboard, an additional image capturing device for capturing the image of the user's gesture is required. Therefore, it is quite inconvenient for a user to perform touch operation as well as gesture operation by using the same apparatus.

The information disclosed in this “BACKGROUND OF THE INVENTION” section is only for enhancement understanding of the background of the invention and therefore it may contain information that does not form the prior art that is already known to a person of ordinary skill in the art. Furthermore, the information disclosed in this “BACKGROUND OF THE INVENTION” section does not mean that one or more problems to be solved by one or more embodiments of the invention were acknowledged by a person of ordinary skill in the art.

### SUMMARY OF THE INVENTION

One object of the invention is to provide a gesture interactive operation method able to overcome the aforementioned technical problems.

Other objects and advantages of the invention can be further illustrated by the technical features broadly embodied and described as follows.

In order to achieve one or a portion of or all of the objects or other objects, the invention provides a gesture interactive operation method, which includes: receiving a plurality pieces of image information, about a user's hand part and provided by an image sensor, when the hand part approaches to a display screen of a touch interactive device and is located within a sensing range of the image sensor; defining, through an image processor, a space relationship among sequentially-adjacent first, second and third fingers of the hand part in each piece of image information; and analyzing the plurality pieces of image information to generate first initiation signal or second initiation signal and initiating the touch interactive device to execute a first operating mode or a second operating mode on the display screen, respectively. The first initiation signal corresponds to the plurality pieces of image information which indicate that the second and third fingers approach to and are physically contacted with each other and the second finger is not physically contacted with the first finger. The second initiation signal corresponds to the plurality pieces of image information which indicate that the first and second fingers approach to and are physically contacted with each other and the second finger is not physically contacted with the third finger.

In summary, the invention provides a gesture interactive operation method able to apply to a touch interactive device. By configuring the image sensor to sense or capture the images of a user's hand part and configuring the image processor to analyze the captured images, a user can perform an interactive operation with the touch interactive device without being equipped with any additional infrared light curtain generator to form a planar light curtain. In addition, by using the gesture of the hand part only, a user can switch the operating modes of the touch interactive device conveniently. Further, because the corresponding functions are executed by using the image sensor to sense the images of a user's hand part, there is no need to concern about the flatness of the display screen; and consequentially, the applied touch interactive device can have a curved screen and therefore the gesture interactive operation method of the invention has a wider application range.

Other objectives, features and advantages of the invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a flow chart of a gesture interactive operation method in accordance with an embodiment of the invention;

FIG. 2 is a flow chart of a gesture interactive operation method in accordance with another embodiment of the invention; and

FIG. 3 is a schematic view of a touch interactive device adapted to be used with the gesture interactive operation method of the invention.

### DETAILED DESCRIPTION OF PREFERRED EMBODIMENTS

In the following detailed description of the preferred embodiments, reference is made to the accompanying drawings which form a part hereof, and in which is shown by way of illustration specific embodiments in which the invention may be practiced. In this regard, directional terminology, such as “top”, “bottom”, “front”, “back”, etc., is used with reference to the orientation of the Figure(s) being described. The components of the invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the invention. Also, it is to be understood that the phraseology and terminology used herein are for the purpose of description and should not be regarded as limiting. The use of “including”, “comprising”, or “having” and variations thereof herein is meant to encompass the items listed thereafter and equivalents thereof as well as additional items. Unless limited otherwise, the terms “connected”, “coupled”, and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

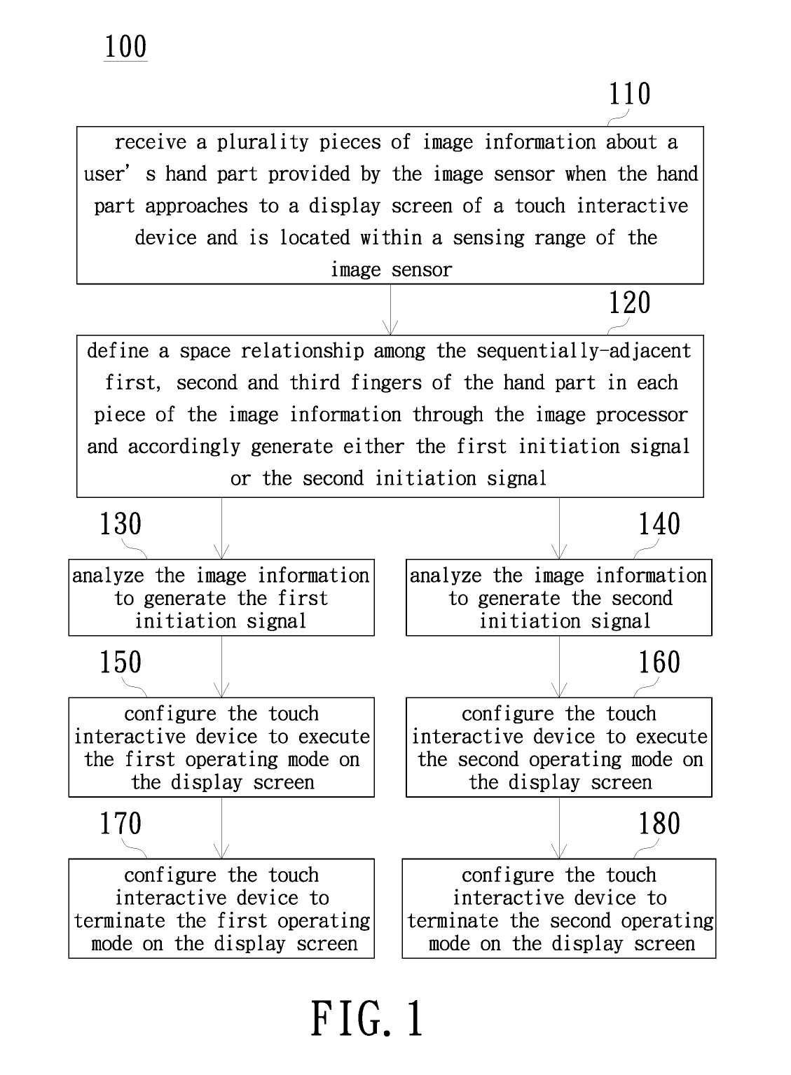

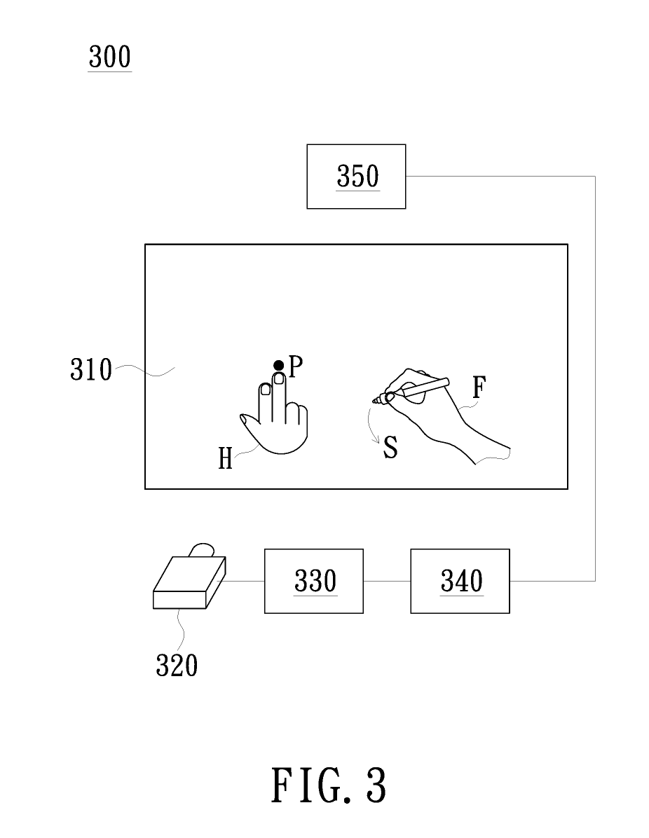

FIG. 1 is a flow chart of a gesture interactive operation method in accordance with an embodiment of the invention. FIG. 3 is a schematic view of a touch interactive device adapted to be used with the gesture interactive operation method of the invention. That is, the gesture interactive operation method 100 of FIG. 1 can apply to the touch interactive device 300 of FIG. 3. It is to be noted that the gesture interactive operation method 100 can be implemented as computer programs and stored in a computer readable storage medium, so that a computer can execute specific commands by reading the computer programs stored in the computer readable storage medium. The computer readable storage medium may be read-only memory, flash memory, floppy disk, hard disk, compact disc, USB flash disc, database able to be accessed via network, or any other type of computer readable storage medium with the similar functions in the art. As shown in FIG. 3, the touch interactive device 300 of the invention is mainly composed of a projector 350 and a display screen 310. In one embodiment, the display screen 310 is an interactive electronic whiteboard. In another embodiment, the display screen 310 is a projection screen. Specifically, the projector 350 is configured to project images onto the display screen 310. An image sensor 320 (e.g., a camera) is configured to sense and capture images of a user's hand part H. An image processor 330 is configured to analyze the images (hereafter is also referred to as image information) captured by the image sensor 320, accordingly generate analyzed image information and transmit the analyzed image information to a control unit 340. The control unit 340 is configured to control the touch interactive device 300 to initiate a corresponding function on the display screen 310 according to the received analyzed image information. Therefore, the user can perform an interactive operation with the touch interactive device 300 without being equipped with any additional infrared light curtain generator to form a planar light curtain. In another embodiment, the touch interactive device 300 is mainly composed of a computer (not shown) and the display screen 310; wherein the display screen 310 is an LCD screen. Specifically, the computer is configured to transmit images to the touch interactive device 300 and the images are displayed on the display screen 310. The image sensor 320 is configured to sense and capture images of the user's hand part H. The image processor 330 is configured to analyze the images captured by the image sensor 320, accordingly generate analyzed image information and transmit the analyzed image information to the control unit 340. The control unit 340 is configured to control the touch interactive device 300 to initiate a corresponding function on the display screen 310 according to the received analyzed image information. Therefore, the user can perform an interactive operation with the touch interactive device 300 through the display screen 310. Further, the image sensor 320, the image processor 330 and the control unit 340 in the embodiment of FIG. 3 are independent devices. However, in another embodiment, the image sensor 320 may be integrated with the projector 350 (or the computer) as one single apparatus, or, the image processor 330 and/or the control unit 340 may be integrated with the image sensor 320, the projector 350 (or the computer) or other devices with similar functions, and the invention is not limited thereto.

Please refer to FIG. 1 and FIG. 3. The gesture interactive operation method 100 of the embodiment includes steps 110˜180, and starts in Step 110. In step 110, a plurality piece of image information, about the user's hand part H and provided by the image sensor 320, are received when the user's hand part H approaches to the display screen 310 of the touch interactive device 300 and is located within a sensing range of the image sensor 320. In step 120, a space relationship among the sequentially-adjacent first finger, second finger and third finger of the user's hand part H in each piece of the image information is defined through the image processor 330. In one embodiment, the first finger is thumb, the second finger is index finger and the third finger is middle finger, but the invention is not limited thereto. In one embodiment, the image sensor 320 is a digital photographic device, which is configured to continuously record or capture the user's hand part H and accordingly generate the plurality piece of image information. Specifically, the image processor 330 analyzes the plurality piece of image information by identifying edge contours of the fingers after receiving the plurality piece of image information and defines the first finger, the second finger and the third finger in each piece of image information by using the determined space relationship (e.g., the length sequence) of the sequentially-adjacent fingers of the user's hand part H. For example, when the user's hand part H approaches to the display screen 310 and is located within a sensing range of the image sensor 320, the image sensor 320 starts to detect and capture the images of the user's hand part H and transmits the corresponding plurality piece of image information to the image processor 330. Then, after receiving the plurality piece of image information, the image processor 330 instantly defines the sequentially-adjacent first, second and third fingers of the user's hand part H in each piece of image information.

In step 120, then, the image information is analyzed and accordingly either first initiation signal or second initiation signal is generated. When the image information is analyzed and accordingly the first initiation signal is generated at step 130, the touch interactive device 300 is initiated to execute a first operating mode on the display screen 310 at step 150. Alternatively, when the image information is analyzed and accordingly the second initiation signal is generated at step 140, the touch interactive device 300 is initiated to execute a second operating mode on the display screen 310 at step 160. Specifically, the image processor 330 further analyzes the image information about the sequentially-adjacent first, second and third fingers of the user's hand part H, accordingly generates either the first initiation signal or the second initiation signal, and then transmits the first initiation signal or the second initiation signal to the control unit 340. Consequentially, the control unit 340 initiates the touch interactive device 300 to execute the first operating mode on the display screen 310 if the first initiation signal is received from the image processor 330; or, the control unit 340 initiates the touch interactive device 300 to execute the second operating mode on the display screen 310 if the second initiation signal is received from the image processor 330. In the embodiment, the control unit 340 is a central processing unit (CPU). The structure and function of a central processing unit are well known to those who are skilled in the art and no redundant detail is to be given herein.

Specifically, the first initiation signal corresponds to the image information which indicates that the second and third fingers of the user's hand part H, which is the one close to the display screen 310, approach to and are physically contacted with each other and the first finger is not physically contacted with the second and third fingers. The second initiation signal corresponds to the image information which indicates that the first and second fingers of the user's hand part H, which is the one close to the display screen 310, approach to and are physically contacted with each other and the third finger is not physically contacted with the first and second fingers. In other words, when the image sensor 320 capture the images of the user's hand part H, the image processor 330 issues the first initiation signal when it is determined that the user's hand part H (the left or right hand) approaches to the display screen 310, the second and third fingers of the hand part H approach to and are physically contacted with each other, and the first finger is not physically contacted with the second and third fingers. In one embodiment, the approach and physical contact of the second and third fingers may be referred as a state that the tip of the second finger touches the third finger; however, the invention is not limited thereto.

When the touch interactive device 300 executes the first operating mode on the display screen 310, a display point P is formed on the display screen 310 when it is determined that the second finger is continuously physically contacted with the third finger and the fingertip of any one of the two fingers approaches to or touches the display screen 310. Specifically, the aforementioned determination is performed by the image processor 330 based on the image information recorded by the image sensor 320. In addition, the position of the display point P on the display screen 310 corresponds to the second finger and the third finger of the user's hand part H. In one embodiment, the display point P is located at the middle position of two points which are respectively projected on the display screen 310 by the fingertips of the second and third fingers. In another embodiment, the display point P is located at the position of one point which is projected on the display screen 310 by the fingertip of the second finger. In still another embodiment, the display point P is located at the position of one point which is projected on the display screen 310 by the fingertip of the third finger. Further, a plotted line is formed on the display screen 310 when it is determined that the second finger and the third finger are continuously physically contacted with each other, the fingertip of any one of the two fingers approaches to or touches the display screen 310 and the fingertip continuously moves along a track; wherein the plotted line displayed on the display screen 310 corresponds to the track of the fingertip. As a result, a user can perform a writing operation on the display screen 310 by making the second finger continuously physically contact with the third finger and making the fingertip of any one of the two fingers approach to or touch the display screen 310.

The image processor 330 is further configured to generate a click signal through analyzing the image information when the touch interactive device 300 executes the first operating mode on the display screen 310. Consequentially, the control unit 340 is further configured to initiate the touch interactive device 300 to execute an application program of a corresponding icon on the display screen 310 when receiving the click signal. Specifically, the image processor 330 generates the click signal when it is determined that the second finger is continuously physically contacted with the third finger, the first finger successively touches the second finger and then moves away from the second finger two times within a preset time period, and the fingertip of the second finger or the third finger touches the icon displayed on the display screen 310. Therefore, the icon on the display screen 310 having a position corresponding to the fingertip of any one of the second finger or the third finger is doubled clicked in response to the click signal. In other words, after the display point P is formed on the display screen 310 by making the second finger continuously physically contact with the third finger and then the display point P is moved to a specified icon on the display screen 310, the image processor 330 generates the click signal when the image information captured by the image sensor 320 indicates that the first finger successively touches the second finger and then moves away from the second finger two times within a preset time period. The image processor 330 then transmits the click signal to the control unit 340; and therefore, the control unit 340 initiates the touch interactive device 300 to execute an application program of the icon on the display screen 310.

Further, when the touch interactive device 300 executes the first operating mode on the display screen 310, the image information is analyzed and accordingly a first termination signal is generated, so that the in step 170, display screen 310 the touch interactive device 300 terminates the execution of the first operating mode on the display screen 310. The first termination signal corresponds to the image information which indicates that the second and third fingers are separated from and not physically contacted with each other. That is, while the touch interactive device 300 executes the first operating mode on the display screen 310, the image processor 330 generates the first termination signal when the image information captured by the image sensor 320 indicates that the second and the third finger are changed from being physically contacted with each other to being separated from and not physically contacted with each other. The image processor 330 then transmits the first termination signal to the control unit 340; and therefore, the control unit 340 controls t the touch interactive device 300 to terminate the execution of the first operating mode on the display screen 310. In one embodiment, the separation of the second and third fingers may be referred as a state that the tip of the second finger is not physically contacted with the tip of the third finger; however, the invention is not limited thereto.

According to the above adscription, it is understood that the first operating mode may be defined as a touch mode. In the touch mode, a user can have a touch operation with the touch interactive device 300 by making the physically-contacted second and third fingers approach to or touch the display screen 310.

It is to be noted that the touch interactive device 300 is configured not to receive the second initiation signal while executing the first operating mode on the display screen 310; and similarly, the touch interactive device 300 is configured not to receive the first initiation signal while executing the second operating mode on the display screen 310. Therefore, the user needs to first control the touch interactive device 300 to terminate the execution of the first operating mode on the display screen 310 by making the second and third fingers of his/her hand part H from physically contact with each other to separate and not physically contact with each other and then controls the touch interactive device 300 to execute the second operating mode on the display screen 310 by making the first and second fingers physically contact with each other and the third finger not physically contact with the first and second fingers.

In another embodiment, the hand part H may refer to the two hands (that is, the right hand and the left hand) of a user and the generation of the second initiation signal is associated with the two hands of a user. In the embodiment, specifically, the second initiation signal corresponds to the image information which indicates that the right hand's first finger and the respective second finger approach to and are physically contacted with each other and the respective third finger is not physically contacted with the first finger and the second finger and at the same time the left hand's first finger and the respective second finger approach to and are physically contacted with each other and the respective third finger is not physically contacted with the first finger and the second finger.

In the embodiment, the second operating mode may be defined as a gesture mode due to that both of the hands of a user are involved. In the gesture mode, the user can have a gesture operation with the touch interactive device 300 by making, each of the right and left hands, the physically-contacted first and second fingers locate within a certain distance range relative to the display screen 310. For example, the control unit 340 further controls the touch interactive device 300 to perform a page-change operation for the page displayed on the display screen 310 when the images information captured by the image sensor 320 indicates that the physically-contacted first and second fingers (both of the right and left hands) are within the certain distance range relative to the display screen 310 and then the right and left hands are away from each other (or, close to each other in another embodiment) within in a certain time period. In another embodiment, the control unit 340 further controls the touch interactive device 300 to perform a window-switch operation on the display screen 310 when the images information captured by the image sensor 320 indicates that the physically-contacted first and second fingers (both of the right and left hands) are within the certain distance range relative to the display screen 310 and then the right and left hands are away from each other within in a certain time period. It is understood that the aforementioned operations and corresponding gestures are for exemplary purposes only, and the present invention is not limited thereto.

Further, when the touch interactive device 300 executes the second operating mode on the display screen 310, the image information is analyzed and accordingly second termination signal is generated, so that the touch interactive device 300 terminates the execution of the second operating mode on the display screen 310 at step 180. The second termination signal corresponds to the image information which indicates that the first and second fingers of any one of the right or left hand are separated from and not physically contacted with each other. That is, while the touch interactive device 300 executes the second operating mode on the display screen 310, the image processor 330 generates the second termination signal when the image information captured by the image sensor 320 indicates that the first and second fingers of any one of the right or left hand are changed from being physically contacted with each other to being separated from and not physically contacted with each other. The image processor 330 then transmits the second termination signal to the control unit 340; and therefore, the control unit 340 controls the touch interactive device 300 to terminate the execution of the second operating mode on the display screen 310.

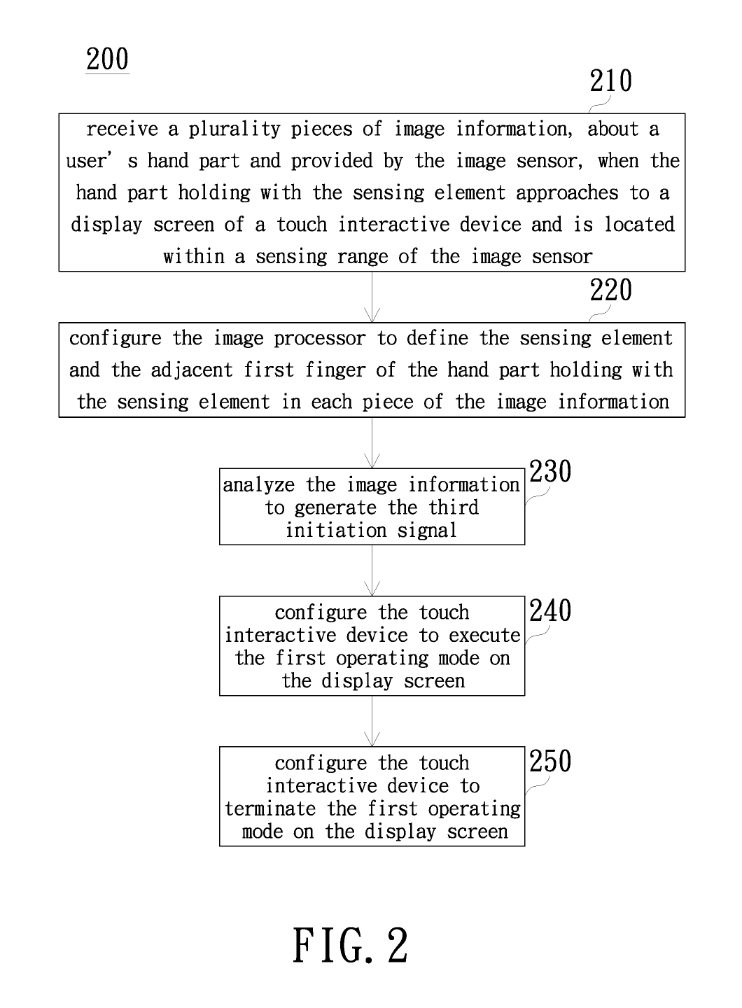

FIG. 2 is a flow chart of a gesture interactive operation method in accordance with another embodiment of the invention. The gesture interactive operation method 200 of FIG. 2 can apply to a touch interactive device, such as the touch interactive device 300 of FIG. 3. In addition, it is to be noted that the gesture interactive operation method 200 can be implemented as computer programs and stored on a computer readable storage medium, so that a computer can execute specific commands by reading the computer programs stored on the computer readable storage medium. The computer readable storage medium may be read-only memory, flash memory, floppy disk, hard disk, compact disc, USB flash disc, database able to be accessed via network, or any other type of computer readable storage medium with the similar functions in the art. As mentioned above, the touch interactive device 300 adopted with the gesture interactive operation method 200 of the embodiment may be mainly composed of a projector and an interactive electronic whiteboard, a projection screen and a projector, or an LCD screen and a computer. The touch interactive device adapted with the gesture interactive operation method 200 in FIG. 2 of the embodiment is substantially same as the touch interactive device 300 adapted with the gesture interactive operation method 100 in FIG. 1, and no redundant detail is to be given herein.

Please refer to FIG. 2 and FIG. 3. The gesture interactive operation method 200 of the embodiment includes steps 210˜250. First, in step 210, a plurality pieces of image information, about a user's hand part F and provided by the image sensor 320, is received when one end of a sensing element S hold by the hand part F approaches to the display screen 310 of the touch interactive device 300 and is located within a sensing range of the image sensor 320. In one embodiment, the sensing element S is a stylus or sticks, etc., but the invention is not limited thereto.

Then, in step 220, the sensing element S and the adjacent first finger of the hand part F holding with the sensing element S are defined, by the image processor 320, in each piece of the image information. Then, in step 230, the image information is further analyzed and accordingly third initiation signal is generated. In step 240, when the image information is analyzed and accordingly the third initiation signal is generated, the touch interactive device 300 is initiated to execute the first operating mode on the display screen 310. Specifically, the third initiation signal corresponds to the image information which indicates that the first finger successively physically contacts with the sensing element S and then moves away from the sensing element S two times within a preset time period and one end of the sensing element S approaches to or touches the display screen 310. The first operating mode of the embodiment is substantially same as the first operating mode in the embodiment of FIG. 1; however, the invention is not limited thereto. As mentioned above, the first operating mode may be defined as a touch mode. In the embodiment, when the touch interactive device 300 executes the touch mode on the display screen 310, the user can have an interactive operation with the touch interactive device 300 by making the hand part F holding with the sensing element S approach to or touch the display screen 310. For example, in the first operating mode, the user can perform a writing operation on the display screen 310 by holding the sensing element S; wherein the track of the line formed on the display screen 310 by the writing operation corresponds to the track of the sensing element S. In the embodiment, the first finger is the index finger for holding the sensing element S, but the invention is not limited thereto.

Further, when the touch interactive device 300 executes the first operating mode on the display screen 310, the image information is analyzed and accordingly third termination signal is generated, so that the touch interactive device 300 terminates the execution of the first operating mode the display screen 310 at step 250. The third termination signal corresponds to the image information which indicates that the first finger successively physically contacts with the sensing element S and then moves away from the sensing element S two times within a preset time period. That is, while the touch interactive device 300 executes the first operating mode on the display screen 310, the image processor 330 generates the third termination signal when the image information captured by the image sensor 320 indicates that the first finger of the user's hand part F successively physically contacts with the sensing element S and then moves away from the sensing element S two times within a preset time period. The image processor 330 then transmits the third termination signal to the control unit 340; and therefore, the control unit 340 controls the touch interactive device 300 to terminate the execution of the first operating mode on the display screen 310.

In summary, the invention provides a gesture interactive operation method able to apply to a touch interactive device. By configuring the image sensor to sense or capture the images of the user's hand part and configuring the image processor to analyze the captured images, the user can perform an interactive operation with the touch interactive device without being equipped with any additional infrared light curtain generator to form a planar light curtain. In addition, by using the gesture of the hand part only, the user can switch the operating modes of the touch interactive device conveniently. Further, because the corresponding functions are executed by using the image sensor to sense the images of the user's hand part, there is no need to concern about the flatness of the display screen; and consequentially, the applied touch interactive device can have a curved screen and therefore the gesture interactive operation method of the invention has a wider application range.

The foregoing description of the preferred embodiment of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like is not necessary limited the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the disclosure is intended to be dedicated to the public regardless of whether the element or component is explicitly recited in the following claims. Furthermore, the terms such as the first stop part, the second stop part, the first ring part and the second ring part are only used for distinguishing various elements and do not limit the number of the elements.

What is claimed is:

1. A gesture interactive operation method, comprising:
receiving a plurality pieces of image information, about a user's hand part and provided by an image sensor, when the hand part of the user approaches to a display screen of a touch interactive device and is located within a sensing range of the image sensor;
defining, through an image processor, a space relationship among sequentially-adjacent first, second and third fingers of the hand part of the user in each piece of image information; and
analyzing the plurality pieces of image information to generate first initiation signal or second initiation signal and initiating the touch interactive device to execute a first operating mode or a second operating mode on the display screen, respectively,
wherein the first initiation signal corresponds to the plurality pieces of image information which indicate that the second and third fingers approach to and are physically contacted with each other and the second finger is not physically contacted with the first finger, wherein the second initiation signal corresponds to the plurality pieces of image information which indicate that the first and second fingers approach to and are physically contacted with each other and the second finger is not physically contacted with the third finger.

2. The gesture interactive operation method according to claim 1, further comprising:
when the touch interactive device executes the first operating mode on the display screen, making the second finger continuously physically contact with the third finger and making a fingertip of any one of the second or third finger approach to or touch the display screen.

3. The gesture interactive operation method according to claim 1, further comprising:
when the touch interactive device executes the first operating mode on the display screen, analyzing the plurality pieces of image information to generate first termination signal and the touch interactive device terminating the execution of the first operating mode on the display screen according to the first termination signal, wherein the first termination signal corresponds to the plurality pieces of image information which indicate that the second and third fingers are separated from and not physically contacted with each other.

4. The gesture interactive operation method according to claim 1, further comprising:
when the touch interactive device executes the second operating mode on the display screen, analyzing the plurality pieces of image information to generate second termination signal and the touch interactive device terminating the execution of the second operating mode on the display screen according to the second termination signal, wherein the second termination signal corresponds to the plurality pieces of image information which indicate that the first and second fingers are separated from and not physically contacted with each other.

5. The gesture interactive operation method according to claim 1, wherein the hand part comprises a right hand and a left hand of the user, and the second initiation signal corresponds to the plurality pieces of image information which indicate that the right hand's first finger and the respective second finger approach to and are physically contacted with each other and the second finger is not physically contacted with the respective third finger and at the same time the left hand's first finger and the respective second finger approach to and are physically contacted with each other and the second finger is not physically contacted with the respective third finger.

6. The gesture interactive operation method according to claim 5, further comprising:
when the touch interactive device executes the second operating mode on the display screen, making the right hand's first finger continuously physically contact with the respective second finger and making the left hand's first finger continuously physically contact with the respective second finger.

7. The gesture interactive operation method according to claim 5, further comprising:
when the touch interactive device executes the second operating mode on the display screen, analyzing the plurality pieces of image information to generate second termination signal and the touch interactive device terminating the execution of the second operating mode on the display screen according to the second termination signal, wherein the second termination signal corresponds to the plurality pieces of image information which indicate that the first and second fingers of any one of the right and left hands are separated from and not physically contacted with each other.

8. The gesture interactive operation method according to claim 1, further comprising:
when the touch interactive device executes the first operating mode on the display screen, analyzing the plurality pieces of image information to generate click signal and the touch interactive device executing an application program of a corresponding icon on the display screen according to the click signal, wherein the click signal corresponds to the plurality pieces of image information which indicate that the second finger is continuously physically contacted with the third finger, the first finger successively touches the second finger and then moves away from the second finger two times within a preset time period, and a fingertip of the second finger or the third finger touches the icon on the display screen.

9. The gesture interactive operation method according to claim 1, wherein the first operating mode is a touch mode, and in the touch mode, the user can have a touch operation by making the physically-contacted second and third fingers approach to or touch the display screen, wherein the second operating mode is a gesture mode, and in the gesture mode, the user can have a gesture operation by making the first and second fingers locate within a certain distance range relative to the display screen.

10. The gesture interactive operation method according to claim 1, further comprising:
when the touch interactive device executes the first operating mode on the display screen, not receiving the second initiation signal; and
when the touch interactive device executes the second operating mode on the display screen, not receiving the first initiation signal.

11. The gesture interactive operation method according to claim 1, further comprising:
when the touch interactive device executes the first operating mode on the display screen, forming a display point on the display screen by making the second finger continuously physically contact with the third finger and a fingertip of any one of second and third fingers approach to or touch the display screen, wherein the display point is located at a middle position of two points which are respectively projected on the display screen by the fingertips of the second and third fingers.

12. The gesture interactive operation method according to claim 1, further comprising:
receiving a plurality pieces of image information, about the user's hand part and provided by the image sensor, when an end of a sensing element hold by the hand part approaches to the display screen and is located within the sensing range of the image sensor;
defining, through the image processor, the sensing element and the adjacent first finger of the hand part holding with the sensing element in each piece of the image information; and
analyzing the plurality pieces of image information to generate third initiation signal and the touch interactive device executing the first operating mode on the display screen according to the third initiation signal, wherein the third initiation signal corresponds to the plurality pieces of image information which indicate that the first finger successively physically contacts with the sensing element and then moves away from the sensing element two times within a preset time period and the end of the sensing element approaches to or touches the display screen.

13. The gesture interactive operation method according to claim 12, wherein the first operating mode is a touch mode, and in the touch mode, the user can have a touch operation by making the sensing element approach to or touch the display screen.

14. The gesture interactive operation method according to claim 12, further comprising:
when the touch interactive device executes the first operating mode on the display screen, analyzing the plurality pieces of image information to generate third termination signal and the touch interactive device terminating the execution of the first operating mode on the display screen according to the third termination signal, wherein the third termination signal corresponds to the plurality pieces of image information which indicate that the first finger successively physically contacts with the sensing element and then moves away from the sensing element two times within a preset time period.
